(19) United States
(12) Patent Application Publication
(10) Pub. No.: US 2026/0066343 A1
(43) Pub. Date: Mar. 5, 2026

(54) Rapid dry microwave synthesis of argyrodite solid electrolytes

(71) Applicants: Alliance for Sustainable Energy, LLC, Golden, CO (US); Colorado School of Mines, Golden, CO (US)

(72) Inventors: Austin Merritt SHOTWELL, Lakewood, CO (US); Maxwell Connor SCHULZE, Arvada, CO (US); Annalise Elizabeth MAUGHAN, Westminster, CO (US)

(21) Appl. No.: 19/317,475

(22) Filed: Sep. 3, 2025

Related U.S. Application Data
(60) Provisional application No. 63/690,003, filed on Sep. 3, 2024.

(51) Int. Cl. H01M 10/0562

(52) U.S. Cl. CPC H01M 10/0562; H01M 2300/008

(57) ABSTRACT

Described herein are methods for the generation of argyrodite solid electrodes utilizing a dry microwave process, removing the necessity of additional mechanical processing, solvent removal and high temperature annealing. The described methods reduce both time and cost for generating argyrodite materials, while maintaining phase purity and electrochemical properties that make argyrodites desirable as electrolytes. The provided methods and materials are versatile and can be used with a variety of argyrodite compositions, including Li_{7-y}PS_{6-y}X_{y} (X═Cl, Br, I).

### CROSS-REFERENCE TO RELATED APPLICATIONS

This application claims priority from U.S. Provisional Patent Application No. 63/690,003, filed on Sep. 3, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Argyrodite solid electrolytes represent an exciting area of battery development as argyrodites have potential to be a lower cost and safer alternative to traditional electrolytes while enabling new electrode chemistries. Argyrodites, including Li_{7-y}PS_{6-y}X_{y} (X═Cl, Br, I), are considered a leading class of solid-state electrolytes due to their high ionic conductivity and exhibit reasonable compatibility with lithium. However, complex processing requirements such as high energy ball milling, pellet pressing and long anneal times in current manufacturing methods mean that cost remains a factor when competing with other electrolyte systems.

Recent advances have suggested that microwave heating in the presence of an ACN solvent is an alternative to mechanical processing. However, these methods require removal of the solvent and high temperature annealing, reducing the benefits over traditional processing. For example, recently published work has reported the dry synthesis of Li₆₋ₓPS₅₋ₓCl₁₊ₓ through microwave heating between 450-550° C. for 10-30 minutes. However, this method still requires ball milling and pellet pressing to prevent substantial (˜13-32 wt %) impurities. Even with ball milling, X-ray diffraction indicates the presence of a small (1.3-2.6 wt %) LiCl impurity phase, while additional unknown Raman active impurity phases were observed. It can be seen from the foregoing that there remains a need in the art for facile, cost-efficient manufacturing techniques of argyrodite solid electrolytes.

### SUMMARY

Described herein are methods for the generation of argyrodite solid electrodes utilizing a dry microwave process, removing the necessity of additional mechanical processing, solvent removal and high temperature annealing. The described methods reduce both time and cost for generating argyrodite materials, while maintaining phase purity and electrochemical properties that make argyrodites desirable as electrolytes. The provided methods and materials are versatile and can be used with a variety of argyrodite compositions, including Li_{7-y}PS_{6-y}X_{y} (X═Cl, Br, I) halides.

In an aspect, provided is a method comprising: i) providing a powdered argyrodite precursor; and exposing the powdered argyrodite precursor to microwave radiation, thereby generating an argyrodite material.

In an aspect, provided is a material comprising: an argyrodite solid, wherein the argyrodite solid is generated by the methods described herein.

In an aspect, provided is a material comprising: an argyrodite solid electrolyte comprising Li_{7-y}PS_{6-y}X_{y}, where X═Cl, Br, or I; wherein the reference analog of the argyrodite solid electrolyte is less than or equal to 5 mol % of electrolyte. The material may be generated by exposing a precursor to microwave radiation in the absence of a solvent.

The step of exposing may be performed without a solvent present in the powdered argyrodite precursor. The step of exposing may be performed where the precursor is proximate to a susceptor, for example, charcoal which generates local thermal energy to either drive or help drive the conversion of the precursor into the argyrodite.

The argyrodite may be a lithium phosphorous sulfur halide, including for example, Li₆PS₅Cl, Li₆PS₅Br, Li₆PS₅I or a combination thereof.

The microwave radiation is electromagnetic radiation and may have a wavelength selected from the range of 1 m to 1 mm.

The microwave radiation may be provided at a power or energy flux selected from the range of less than 5000 W/m², 500 W/m² to 2500 W/m², 1000 W/m² to 2000 W/m² or at about 1200 W/m². The step of exposing the powdered argyrodite precursor to the microwave radiation may be performed for a time period of less than 2 hrs, less than 1 hour, less than 30 min, or optionally, less than 20 min.

The argyrodite material may be or may be useful as a solid material in an electrochemical cell, for example, a battery.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates the microwave method for the synthesis of argyrodites. In the upper portion is a graphical representation of the method, while the lower portion shows images of the microwave setup.

FIG. 2 provides a photograph of the EIS jig used to apply consistent pressure to pellets for electrochemical spectroscopy.

FIGS. 3A-3D show the argyrodite structure (Li₆PS₅Br) (FIG. 3A) and Rietveld Refinements of Li₆PS₅Cl (FIG. 3B), Li₆PS₅Br (FIG. 3C), and Li₆PS₅I (FIG. 3D). Materials synthesized via the microwave method are plotted above reference materials. The refinements include impurity phases.

FIGS. 4A-4C provide Raman spectra of (FIG. 4A) Li₆PS₅Cl, (FIG. 4B) Li₆PS₅Br, and (FIG. 4C) Li₆PS₅I synthesized via the reference solid state method (lower) and the novel microwave method (higher). Orange markers below the data indicate the positions of signals expected from PS³⁻ units and the corresponding vibrational modes. Signals at 160 cm⁻¹ and 450 cm⁻¹ are artifacts from background subaction.

FIG. 5 shows Raman spectrum of Li₆PS₅Cl illustrating high wavenumber fluorescence in the microwaved material. Inset shows comparable behavior from Li₆PS₅Cl prepared via microwave assisted wet synthesis.

FIGS. 6A-6B show SEM images of Li₆PS₅Br prepared via the reference solid state method (FIG. 6A) and the described microwave method (FIG. 6B). Similar grain sizes and homogeneity indicate comparable morphologies.

FIGS. 7A-7B show SEM images of Li₆PS₅Cl prepared via the reference solid state method (FIG. 7A) and the described microwave method (FIG. 7B). Similar grain sizes and homogeneity indicate comparable morphologies.

FIGS. 8A-8B show SEM images of Li₆PS₅I prepared via the reference solid state method (FIG. 8A) and the described microwave method (FIG. 8B). Similar grain sizes and homogeneity indicate comparable morphologies.

FIGS. 9A-9B show EDS spectra of Li₆PS₅Br prepared via the reference solid state method (FIG. 9A) and the described microwave method (FIG. 9B). The bright spot in the silicon pane (upper right) of the solid state method (FIG. 9A) EDS spectrum was likely due to a small piece of fused silica from the ampoule used to prepare the sample.

FIGS. 10A-10B show EDS spectra of Li₆PS₅Cl prepared via the reference solid state method (FIG. 10A) and the described microwave method (FIG. 10B).

FIGS. 11A-11B show EDS spectra of Li₆PS₅I prepared via the reference solid state method (FIG. 11A) and the described microwave method (FIG. 11B).

FIG. 12 provides the equivalent circuit used to fit EIS data. Elements labeled R are resistors and elements labelled Q are constant phase elements (CPE), which model non-ideal capacitive contributions to the impedance.

FIGS. 13A-13C provide 30° C. Nyquist plots of (FIG. 13A) Li₆PS₅Cl, (FIG. 13B) Li₆PS₅Br, and (FIG. 13C) Li₆PS₅I synthesized via the reference solid state method (SSM) and the described microwave method (MW). Unfilled markers correspond to data, while the traces correspond to the calculated fits. FIGS. 13D-13F summarize important electrochemical properties. FIG. 13D summarizes the activation energies, 13E summarizes ionic conductivity, 13F summarizes the Arrhenius prefactor. For FIGS. 12D-12F, microwaved materials are presented as filled triangles, while reference materials are represented by open circles.

FIGS. 14A-14B provide temperature dependent Nyquist plots of Li₆PS₅Br prepared via the reference solid state method (FIG. 14A) and the described microwave method (FIG. 14B).

FIGS. 15A-15B provide temperature dependent Nyquist plots of Li₆PS₅Cl prepared via the reference solid state method (FIG. 15A) and the described microwave method (FIG. 15B).

FIGS. 16A-16B provide temperature dependent Nyquist plots of Li₆PS₅I prepared via the reference solid state method (FIG. 16A) and the described microwave method (FIG. 16B).

FIG. 17 provides Arrhenius plots of microwaved and reference argyrodites. The error bars represent the standard deviation between values extracted from multiple spectra collected of the same cell. The lines represent linear regressions of the data. Activation energies were extracted from the linear regressions and the 95% confidence intervals are shown.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

As used herein, the term “microwave radiation” refers to electromagnetic radiation in the microwave range, for example, selected from the range of 300 Mhz to 300 Ghz, including, from a standard commercial kitchen microwave.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

### Example 1—Rapid, Dry, Microwave Synthesis of Argyrodite Solid Electrodes

### Materials Synthesis

Li₆PS₅Cl, Li₆PS₅Br, and Li₆PS₅I were synthesized via a traditional solid state method to serve as reference materials. Stoichiometric amounts of Li₂S, P₂S₅, and LiX (X═Cl, Br, I) were hand ground with an agate mortar and pestle until visually homogeneous (˜15 minutes) and transferred into 50 mL zirconia ball milling jars along with 25 units of 10 mm zirconia milling media. The precursor mixes were then ball milled in a MSE Pro 0.4 L planetary ball mill (Product Number: MA0101) at 400 rpm (main disk) continuously for 24 hours. The precursor mixes were then removed from the ball mill jars and briefly hand ground. 6 mm pellets of each precursor mix were pressed at ˜80 bar of uniaxial pressure and annealed in pyrolyzed silica ampoules for 96 hours at 550° C. (heating ramp rate: 5° C./minute, natural cool). The resulting materials were extracted from their ampoules by scoring the ampoules with a diamond bladed saw and breaking the ampoules open in an argon filled glovebox with a pair of glass cutters. The materials were then briefly hand ground and analyzed as prepared.

### Microwave Method

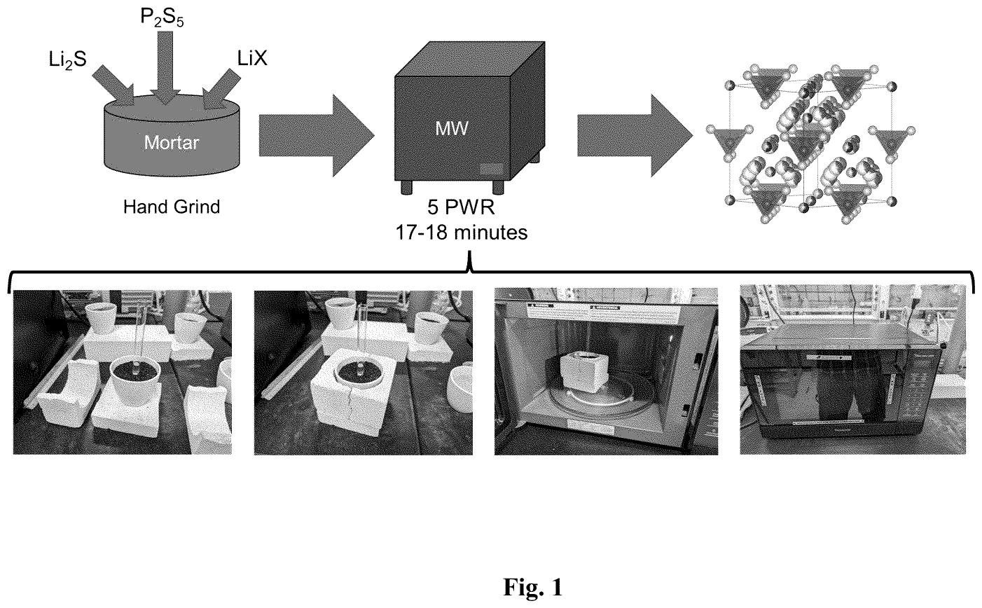

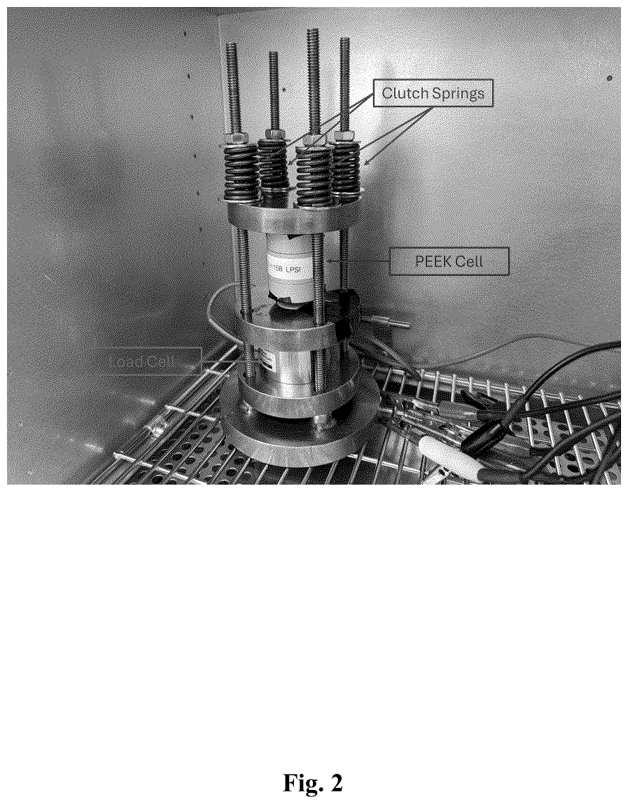

Li₆PS₅Cl, Li₆PS₅Br, and Li₆PS₅I were prepared via the following microwave method. Stoichiometric amounts of Li₂S, P₂S₅, and LiX (X═Cl, Br, I) were well ground with an agate mortar and pestle (˜40 minutes) and ˜0.25 g of the resulting powder was transferred to a fused silica ampoule. The ampoule was flame sealed and immersed in a 200 mL alumina crucible filled with ˜80 g of activated charcoal. The crucible was then placed in an insulating assembly consisting of a slab of firebrick under the crucible and a piece of firebrick with a circular hole sufficiently large to accommodate the crucible within it. The assembly is illustrated in the lower portion of FIG. 1. The resulting assembly was then placed off center in an inverter-powered 1200 W microwave (Panasonic® NN-SN65 KB) and microwaved at power level 5 for 17 min for Li₆PS₅Cl or 18 min for Li₆PS₅Br and Li₆PS₅I. The turntable was permitted to rotate for the duration of the synthesis time. The crucible was immediately removed from the microwave and the firebrick assembly and allowed to cool to room temperature before removing the ampoule. Samples were extracted from their ampoules and briefly hand ground for subsequent analysis. Prior to performing reactions, the microwave and activated charcoal preheated by microwaving ˜80 g of activated charcoal in the previously described assembly for 15 minutes at power level 5. We note that samples prepared by this method melted and resolidified in the ampoules.

### X-Ray Diffraction and Total Scattering Analysis

Powdered samples of materials prepared via solid-state and microwave methods were loaded in 0.7 mm ID quartz capillaries and sealed with two-part epoxy. Capillaries were used for both high-resolution diffraction and total scattering measurements. High-resolution synchrotron powder X-ray diffraction (SXRD) data were collected at the Wiggler High Energy (WHE) Beamline at the Brockhouse Diffraction Sector of the Canadian Light Source. High-resolution powder X-ray diffraction patterns were collected using a Varex XRD 4343CT 2D plate detector and 30.34 keV photons (λ=0.4087 Å) Samples were measured in transmission geometry at ambient temperature and spun in a capillary spinner during the measurement to mitigate any effects of preferred orientation. Synchrotron X-ray scattering data suitable for pair distribution function analysis (XPDF) were collected at the WHE Beamline at the Brockhouse Diffraction Sector of the Canadian Light Source. Total scattering data were collected using 60.69 keV photons (λ=0.2043 Å) to Q=26 Å⁻¹ in transmission geometry using a Varex XRD 4343CT 2D plate detector at a sample-to-detector distance of 169.01 mm. The sample-to-detector distance was calibrated using a Ni standard. Raw total scattering data were integrated into Q-space in GSAS-II, applying a mask and polarization correction during integration. The normalized total scattering patterns S (Q) were produced by subtracting background scattering from an empty quartz capillary, utilizing the appropriate sample compositions, and applying standard corrections for the area detector setup. Pair distribution function patterns, G(r), were calculated via Fourier transformation of the total scattering data utilizing Qmax=25 Å⁻¹ and smoothed using a Lorch damping function to suppress Fourier termination ripples. Values of Qdamp=0.0875(3) Å⁻¹ and Qbroad=0.024(1) Å⁻¹ were extracted from refinement of a Ni standard in TOPAS v6 and used for further modeling. Diffraction and total scattering data were analyzed via joint refinement in TOPAS v6.

### Raman Spectroscopy

Raman spectra were collected on a Thermo Scientific Nicolet iS50 FTIR spectrometer with an FT-Raman module. A CaF₂ beamsplitter and InGaAs detector were employed for all reported spectra. Samples were analyzed with 0.05 W of laser intensity (λ=1064 nm), 1000 replicate scans, autogain on, and a resolution of 2 cm⁻¹. Aperture settings employed for each sample are detailed in Table 1.

TABLE 1
Aperture settings employed for selected materials

| Synthetic | | |
|---|---|---|
| Method | Material | Aperture |
| Microwave | Li₆PS₅Cl | 37 |
| Reference | Li₆PS₅Cl | 37 |
| Microwave | Li₆PS₅Br | 10 |
| Reference | Li₆PS₅Br | 30 |
| Microwave | Li₆PS₅I | 10 |
| Reference | Li₆PS₅I | 10 |

Samples were prepared by placing powdered samples on a dual concavity microscope slide and sealing the concavity with polyimide tape. Raman spectra were collected by placing the prepared microscope slides in the appropriate sample holder with the polyimide tape facing down (away from the light source). A blank sample was measured under identical conditions and used for background subtraction.

### AC Electrochemical Impedance Spectroscopy

AC electrochemical impedance spectroscopy (EIS) was used to probe lithium ion transport. Powdered samples were densified into pellets (O.D.=6 mm) by uniaxial pressing at ˜1000 MPa. Pellets were further densified by cold isostatic pressing at 30 MPa for 30 min. The resulting densities as a percent of theoretical density are summarized in Table 1. Cells were assembled in a two-electrode, parallel-plate capacitor geometry in home-built air-free polyether ether ketone (PEEK) housing with graphite foil electrodes. Stainless steel rods were used to provide electrical contact and pressure to the pellets during measurement. Potentiostatic EIS measurements were performed using a Gamry Interface 1010E Potentiostat under a constant applied pressure of 40 MPa, as measured by an in-line load cell. The frequency was swept from 2×10⁶ Hz to 0.2 Hz with an applied bias of 20 mV and 10 measurements per decade. For temperature-dependent studies, the cell was placed in a convection oven and the oven was allowed to dwell at each temperature for 1.5 hr after equilibrating, with spectra collected approximately every 10 min. Three spectra at each temperature were modeled with the equivalent circuit method and fitted values were averaged at each temperature point.

### Scanning Electron Microscopy and Energy-Dispersive X-Ray Spectroscopy

Scanning Electron Microscopy (SEM) and Energy-Dispersive X-ray Spectroscopy (EDS) data were collected on a Hitachi S-4800 microscope using an accelerating voltage of 15 kV. Powdered samples were affixed to double sided copper tape on an SEM sample stage and transferred to the instrument in a sealed vessel under argon. During instrument loading, samples were exposed to atmosphere for ˜10 s before vacuum was applied.

### Results and Discussion

Thorough structural, morphological, and electrochemical analysis of the microwave and reference materials reveal that the described method produces materials that are broadly comparable or superior to those synthesized via the reference method in phase purity, morphology, and electrochemical performance. It is of note that although the microwaved Li₆PS₅I exhibited more abundant impurity phases relative to its reference analogue, its ionic conductivity was a full order of magnitude better than that of its reference analogue.

### Structure and Morphology

Structural characterization of all described materials in this example consisted of joint refinement of synchrotron powder X-ray diffraction as well as Raman spectroscopy. The joint refinement of X-ray techniques provides comprehensive information regarding average and local structure, while Raman spectroscopy provides insight into bonding motifs and molecular moieties within the structure

### X-Ray Diffraction

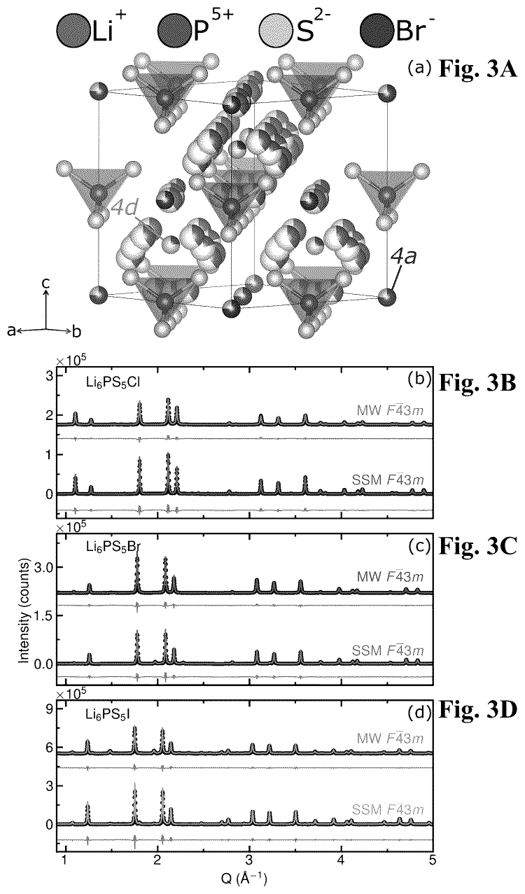

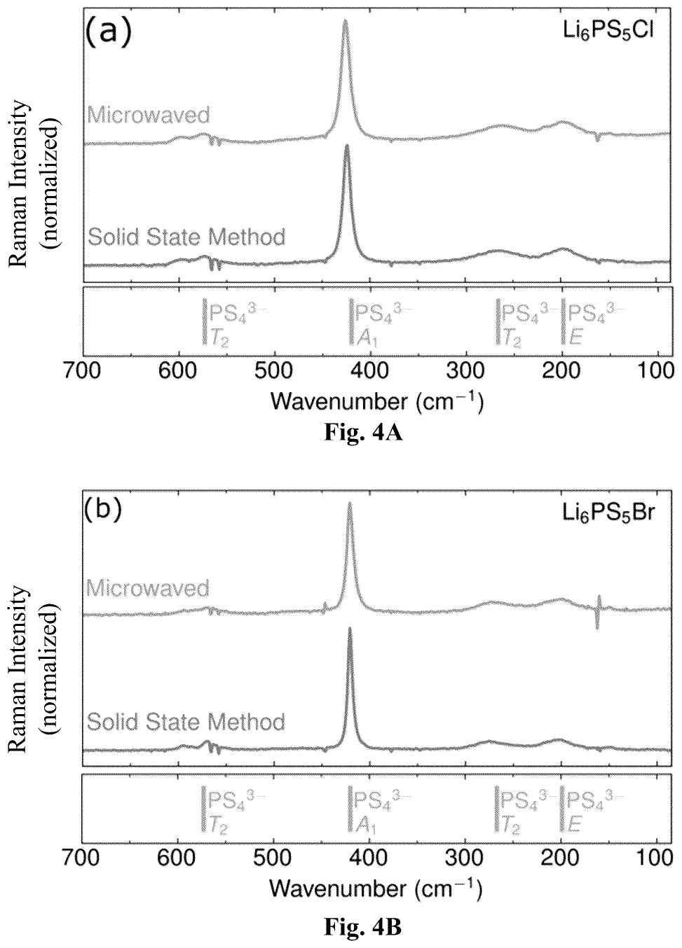

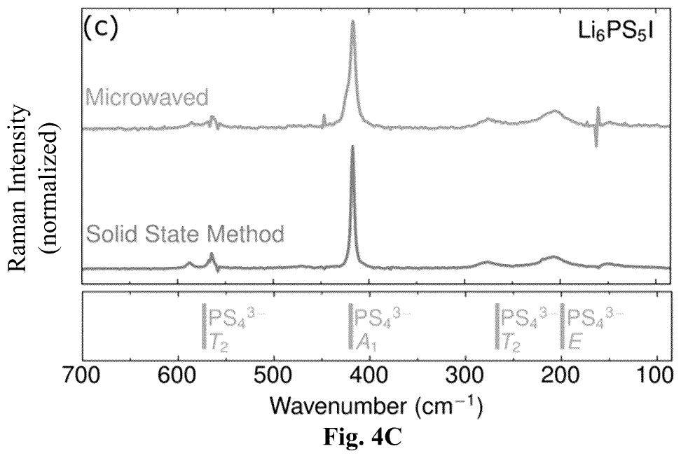

The halide argyrodites Li₆PS₅X (X═Cl⁻, Br⁻, I⁻) are prepared by rapid microwave synthesis and compared their structures to materials prepared by conventional solid-state synthesis. All six materials crystallize in the cubic argyrodite structure (space group F⁻ 43m, FIG. 3A), as evidenced by high-resolution synchrotron powder X-ray diffraction (SXRD) patterns shown in FIG. 3B-3D. The cubic halide argyrodite structural models were refined against the SXRD data using the Rietveld method, and refined structural parameters are tabulated in Table 2. We find that the cubic lattice parameters are nearly identical between the microwave and solid-state methods for a given choice of halide Microwaved Li₆PS₅Cl and Li₆PS₅Br were phase pure to the resolution of our data, while their reference analogues exhibited 10.56 mol % LiCl and 9.71 mol % LiBr impurity phases, respectively. The reference Li₆PS₅I exhibited 3.23 mol % Lil and 3.05 mol % Li₄PS₄I impurity phases, while the microwave method resulted in a 14.46 mol % Li₄PS₄I impurity phase. Previous reports indicate that Li₄PS₄I is an ion conducting phase with a room temperature ionic conductivity of ≈10⁻⁵-10⁻⁴ S/cm.

TABLE 2
Refined structural parameters from Rietveld refinements of the halide argyrodite structure
against high-resolution SXRD data for both microwave and solid-state methods.

| | Li₆PS₅Cl | | Li₆PS₅Br | | Li₆PS₅I | |
|---|---|---|---|---|---|---|
| | MW | SSM | MW | SSM | MW | SSM |
| a (Å) | 9.8498(3) | 9.8516(3) | 9.9937(2) | 9.9905(1) | 10.1516(2) | 10.1439(2) |
| S 16e pos. (x, −x, x + 0.5) | 0.1205(2) | 0.1202(2) | 0.1193(2) | 0.1184(2) | 0.1171(2) | 0.1168(2) |
| S 16e Uᵢₛₒ (Å²) | 0.0430(8) | 0.0362(9) | 0.039(1) | 0.028(1) | 0.016(1) | 0.013(1) |
| P⁵⁺ Uᵢₛₒ (Å²) | 0.024(1) | 0.016(1) | 0.030(2) | 0.017(2) | 0.008(1) | 0.006(1) |
| X⁻ 4a occ. | 0.76(5) | 0.77(6) | 0.753(5) | 0.847(6) | 0.930(4) | 0.964(4) |
| 4a Uᵢₛₒ (Å²) | 0.038(1) | 0.034(2) | 0.029(1) | 0.033(1) | 0.02660(4) | 0.0243(8) |
| 4d Uᵢₛₒ (Å²) | 0.024(2) | 0.021(2) | 0.025(1) | 0.021(2) | 0.028(2) | 0.020(2) |
| R_{wp} (%) | 3.74 | 6.45 | 4.31 | 4.98 | 6.09 | 9.002 |

### Raman Spectroscopy

Raman spectra of all synthesized materials were collected to interrogate the molecular moieties present in the prepared argyrodites. This technique pairs incredibly well with X-ray methods as it probes the bonding environments present, while X-ray techniques are purely positional—they cannot distinguish between two atoms that are close to one another and two atoms that are bonded to one another.

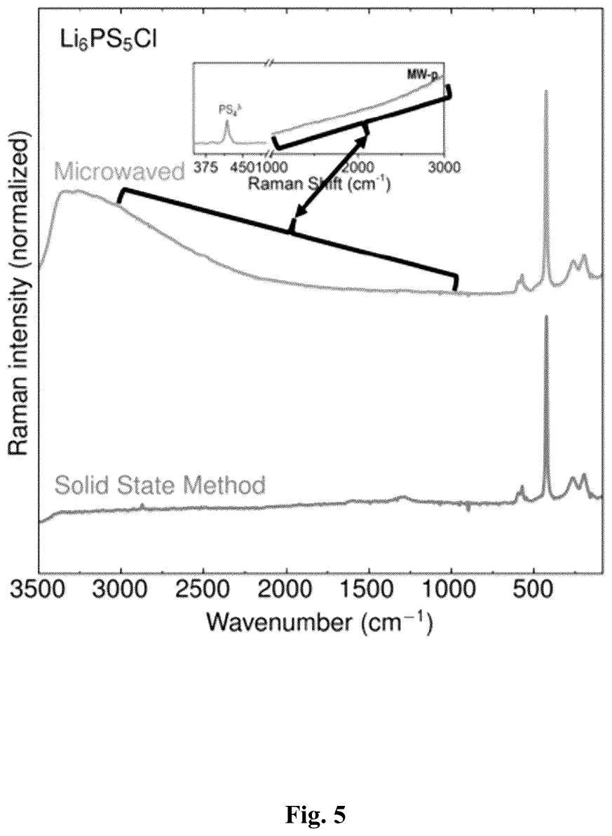

Raman spectra of materials synthesized via both the microwave method and the reference method (FIG. 5) are consistent with the formation of the argyrodite phase. It is well established that the PS³⁻₄ tetrahedra, or their substituted analogues, are the only Raman-active moieties present in phase pure argyrodites. Features attributable to PS³⁻₄ tetrahedral units are present in all collected spectra and include the A₁ symmetric stretch at 420 cm⁻¹, T₂ modes at 267 cm⁻¹ and 573 cm⁻¹, and the E mode at 200 cm⁻¹.

In all spectra, the T₂ mode at 573 cm⁻¹ exhibits a shoulder at 600 cm⁻¹. It is of note that this shoulder resolves into a distinct signal in the Li₆PS₅I synthesized via the solid-state method. This shouldering or broadening behavior of the signal attributed to the T₂ mode is consistent with previous reports. Additionally, Raman spectra for the microwaved materials did exhibit fluorescence at higher wavenumbers (FIG. 5), which is consistent with the results reported by Hwang et al. in their microwave-assisted wet synthesis of Li₆PS₅Cl. Signals of other common thiophosphate species and sulfur-sulfur bonding were not observed, indicating that the PS₄³⁻ tetrahedral units are the only Raman-active moieties present in the analyzed materials. The Raman spectra for both methods are consistent with the formation of an argyrodite phase containing no Raman-active impurities, which supports the conclusion that the novel microwave method is an appropriate method for synthesizing argyrodite solid electrolytes. Minor shouldering behavior is observed for the A₁ symmetric mode in MW Li₆PS₅I. We attribute this feature to the A₁ PS₄³⁻ symmetric stretch of the Li₄PS₄I impurity, which has previously been reported to appear at ν=417-425 cm⁻¹.

### Scanning Electron Microscopy

The morphologies of materials made via the solid-state reference method and the novel microwave method were interrogated via scanning electron microscopy (SEM). Both the MW and reference synthesis methods produce highly crystalline halide argyrodites with similar particle morphologies. Scanning electron microscopy (SEM) images reveal polycrystalline morphologies with particle sizes generally below 100 μm. As both the microwaved and reference materials exist in a dense form (pellet or solidified mass) after heating, it is very likely that both grain size and the degree of homogeneity in grain size are primarily determined by the hand grinding step employed after heating.

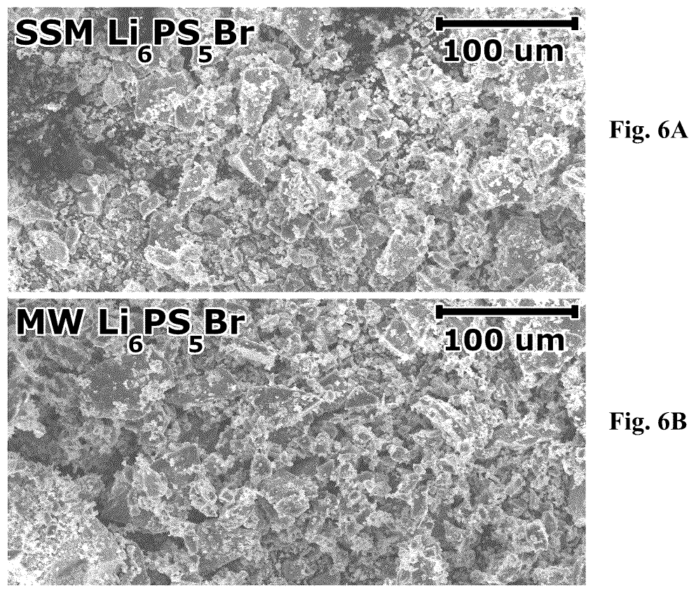

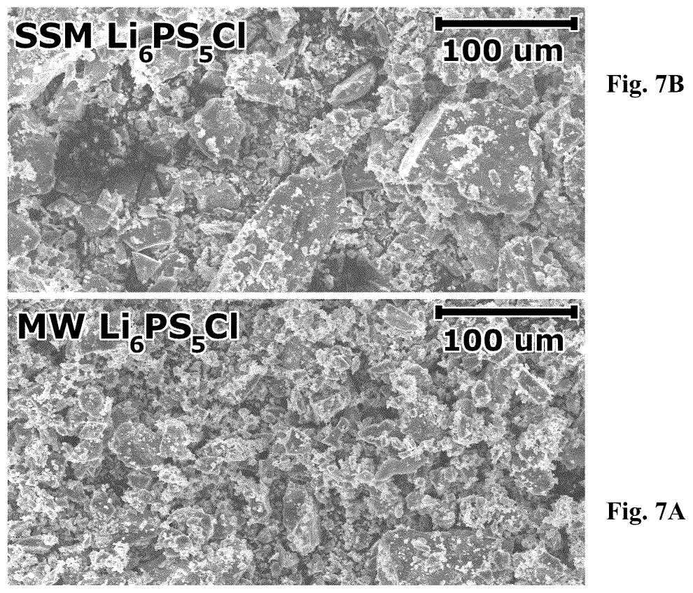

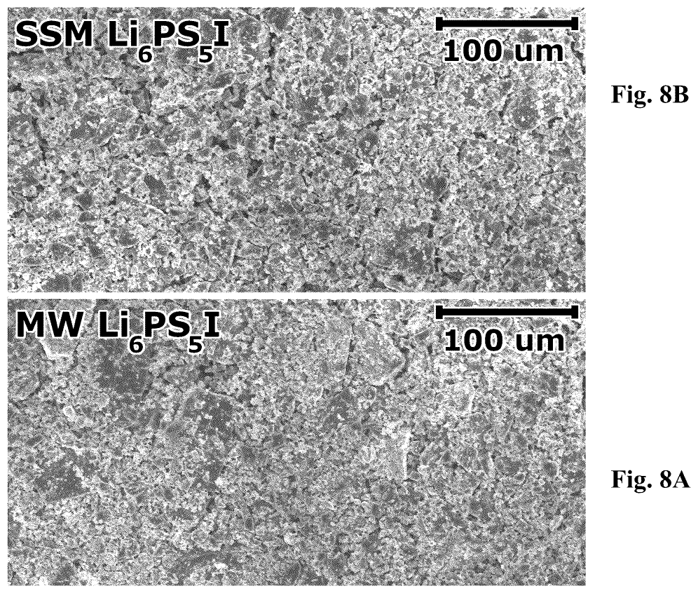

FIGS. 6A-6B show SEM images of Li₆PS₅Br prepared via the reference method (FIG. 6A) and the microwave method (FIG. 6B). Equivalent SEM images for Li₆PS₅Cl and Li₆PS₅I are displayed in FIGS. 7A-7B and FIGS. 8A-9B, respectively. For all three compositions, the morphologies of the reference and microwaved materials were comparable, with similar grain sizes and levels of homogeneity. Both the reference and microwaved Li₆PS₅I exhibited substantially smaller grain sizes than did the Li₆PS₅Cl or Li₆PS₅Br, but the two methods showed equivalent morphological behavior within each chemical system. Given the consistency in morphology resulting from the reference and microwave methods, the microwave method can be considered equivalent to the reference method in its effect on morphological outcomes.

### Energy Dispersive X-Ray Spectroscopy

Energy dispersive X-ray spectroscopy (EDS) was employed to probe the bulk elemental distribution of target elements (phosphorus, sulfur, and halides) as well as to identify any significant elemental impurities in the prepared materials. Phase pure materials should exhibit an approximately even distribution of their constituent elements, while impure materials are likely to contain elementally rich and deficient regions. Further, the presence of non-target elements other than oxygen can be indicative of sample contamination. It should be noted that oxygenated impurities were expected to be present in the EDS spectra of the studied materials due to their brief (approximately 10 seconds) exposure to atmosphere during instrument loading.

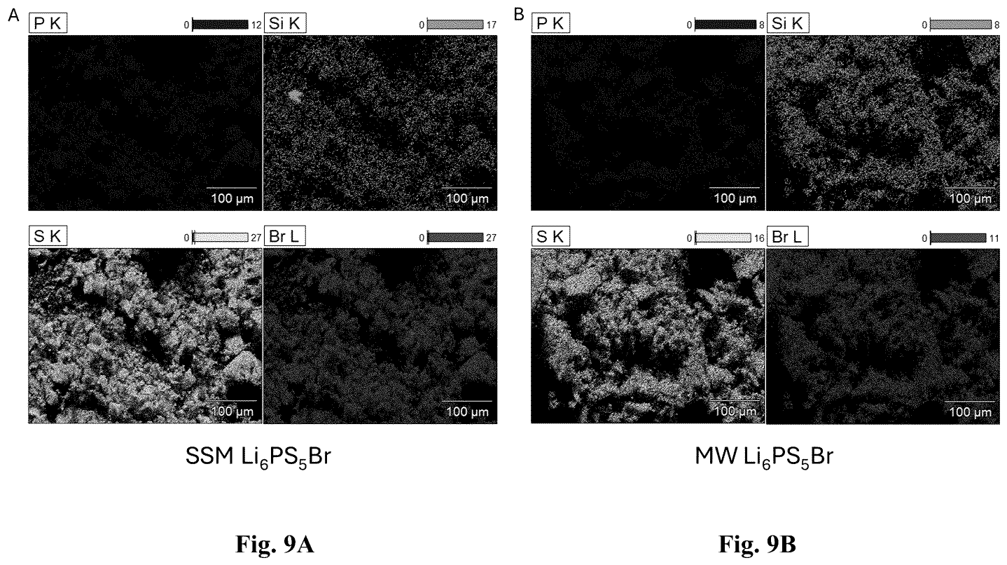

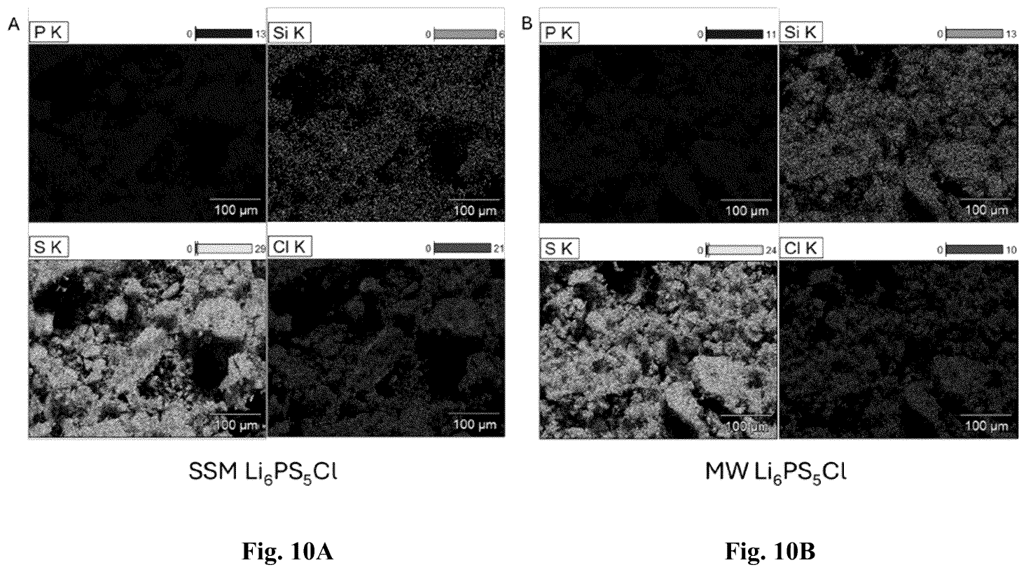

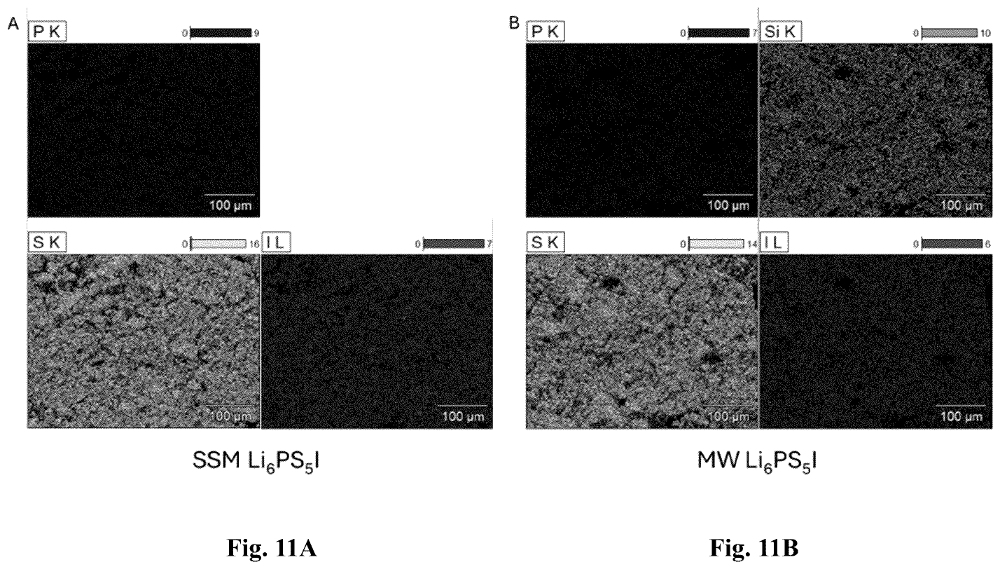

FIGS. 9A-9B display P K-edge, S K-edge, Si K-edge, and Br L-edge EDS spectra for Li₆PS₅Br prepared via the reference method (FIG. 9A) and the microwave method (FIG. 9B). Equivalent spectra for Li₆PS₅Cl and Li₆PS₅I are displayed in FIGS. 10A-10B and FIGS. 11A-11B, respectively. Two things are of particular note in the EDS spectra. First, the spectra show a consistent and even distribution of the target elements (phosphorous, sulfur, and the appropriate halide) for both synthetic methods across all three compositions. This is consistent with the formation of well distributed argyrodite phases. Second, the microwaved argyrodites of all three compositions exhibited elevated silicon content (upper right panes of FIGS. 9B, 10B and 11B) relative to their reference counterparts. We attribute the elevated silicon content to contamination of the samples with a small amount of fused silica from the ampoules used to prepare the samples. The microwaved samples likely contain more silica than those prepared via the reference method due to the differing methods employed to extract the reference materials and the microwaved materials from their ampoules. While the materials prepared via the reference method could easily be extracted from an ampoule by cleanly opening the ampoule with glass cutters and removing the pellet of material with tweezers, the microwaved mate-rials formed solid masses that conformed and adhered to the bottoms of ampoules. As such, extraction of the microwaved materials required that the portion of the ampoule surrounding the material be broken, which likely allowed a small amount of the fused silica that composed the ampoule to contaminate the microwaved argyrodites.

An alternative explanation of the observed increase in silicon content in the microwaved argyrodites is that the elevated temperatures accessed by microwaving or non-thermal effects allowed the microwaved samples to leech silicon from their ampoules and incorporate it into the argyrodite structure in the form of SiS₄⁴⁻. This possibility is unlikely as it would require breaking the strong Si—O bonds of largely inert silica to form the weaker Si—S bonds that could be found in the argyrodite. Previous reports indicate that aliovalent substitution of silicon in place of phosphorus can occur in the argyrodites, which lends some credence to this possibility. If silicon were incorporated into the argyrodites in place of phosphorus, a signal would be expected in the Raman spectra of the materials at 390 cm⁻¹ corresponding to SiS₄⁴⁻ units. As none of the microwaved materials exhibited such a signal, it is safe to conclude that no SiS₄⁴⁻ units were formed and that the elevated silicon content of the microwaved materials is better explained by silica contamination from the process of extricating the microwaved materials from their ampoules than by leeching and incorporation of silicon during heating.

### Electrochemical Performance

Electrochemical impedance spectroscopy (EIS) was used to interrogate the electrochemical performance of the argyrodites synthesized via the novel microwave method and the reference solid state method. Equivalent circuit modeling was performed to extract the ionic conductivity of the materials and temperature dependent studies were performed to calculate activation energies for lithium transport via the Arrhenius relationship. In sum, our EIS studies demonstrate that the novel microwave method generates Li₆PS₅Cl and Li₆PS₅Br with ionic conductivities and activation energies comparable to their reference analogues, while the Li₆PS₅I prepared via the microwave method exhibited superior ionic conductivity and a comparable activation energy when compared to its reference analogue.

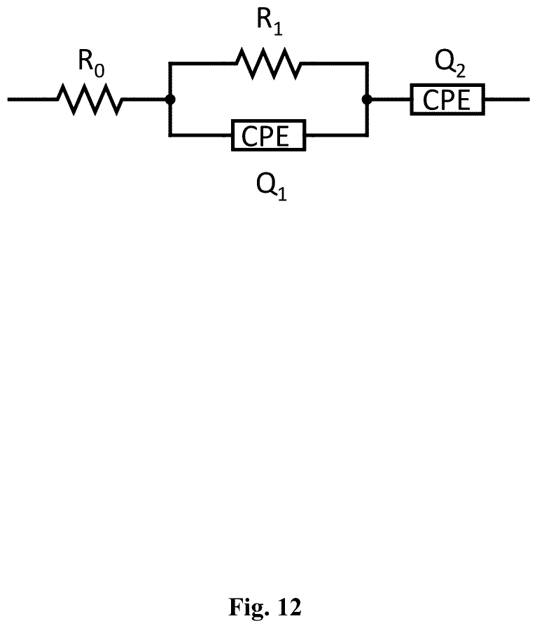

EIS data were fit in a Python environment using the PyEIS package using the equivalent circuit displayed in FIG. 12. The equivalent circuit used for fitting consisted of a resistor (R₀) in series with an RQ element composed of a resistor (R₁) and constant phase element (Q₁, CPE) in parallel and a CPE (Q₂). R₀ models the inherent resistance of the experimental setup, including resistance from wires and electrical contacts; the R₁Q₁ element models the bulk ionic behavior of the electrolyte; and the Q₂ element models the capacitive behavior of the material at low frequencies. CPEs are used instead of capacitors to appropriately model the non-ideality of both the electrolyte bulk ionic behavior and the imperfectly blocking nature of the electrodes. Values for R₀ were found to be universally close to or equal to 0, indicating that the resistance of our equipment was effectively negligible.

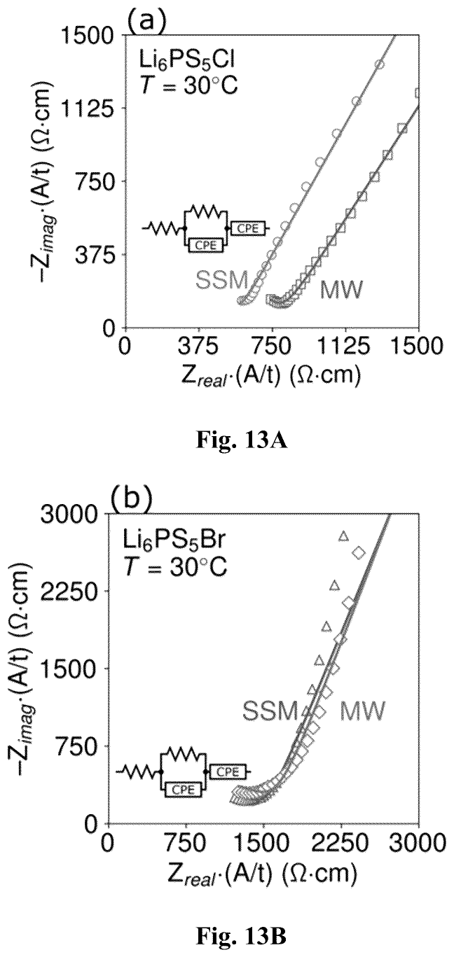

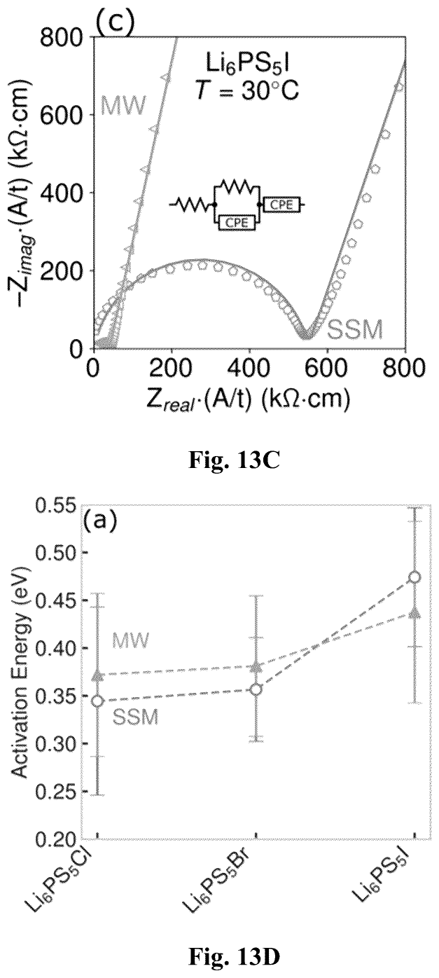

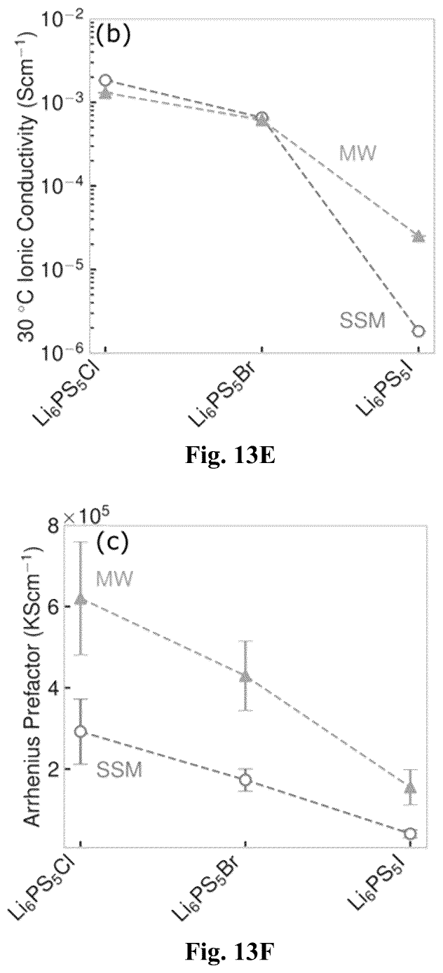

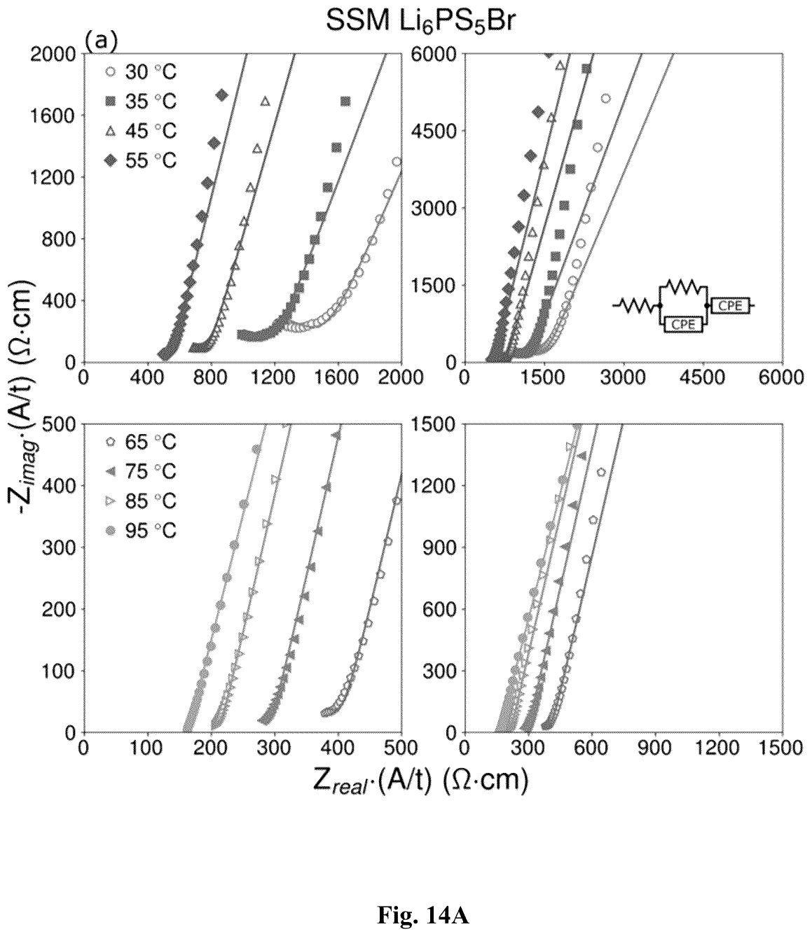

Due to fluctuations in the laboratory temperature and a thermal floor greater than 25° C., 30° C. Nyquist plots and extracted ionic conductivities were prepared in place of room temperature equivalents. As illustrated in FIG. 13E, the novel microwave method generates Li₆PS₅Cl and Li₆PS₅Br with ionic conductivities comparable to, but slightly lower than, those prepared via the reference solid state method. In contrast, the Li₆PS₅I prepared via the microwave method exhibited an ionic conductivity a full order of magnitude greater than its reference material. The slight reduction in ionic conductivity for Li₆PS₅Cl and Li₆PS₅Br associated with the microwave method is likely due to the inclusion of amorphous silica in the samples from the ampoules used during synthesis. As detailed in the EDS section, the microwaved materials could not be extracted without breaking the ampoules containing them, thereby introducing a small amount of silica to the samples. As silica is inert and non-ionically conductive, its inclusion would reduce the ionic conductivity of the microwaved samples. The elevated ionic conductivity observed for the microwaved Li₆PS₅I may be due to increased site disorder across the 4a/4d Wyckoff sites (Table 2), which has previously been associated with fast ion conduction.

It is of note that the Nyquist plots for both the microwaved and reference Li₆PS₅Cl and Li₆PS₅Br did not contain full semicircles. This is due to their high ionic conductivities and the limited frequency range of the potentiostat used to collect EIS data. Collecting EIS data at sub-ambient temperature would likely allow resolution of the full semicircles for the Li₆PS₅Cl and Li₆PS₅Br.

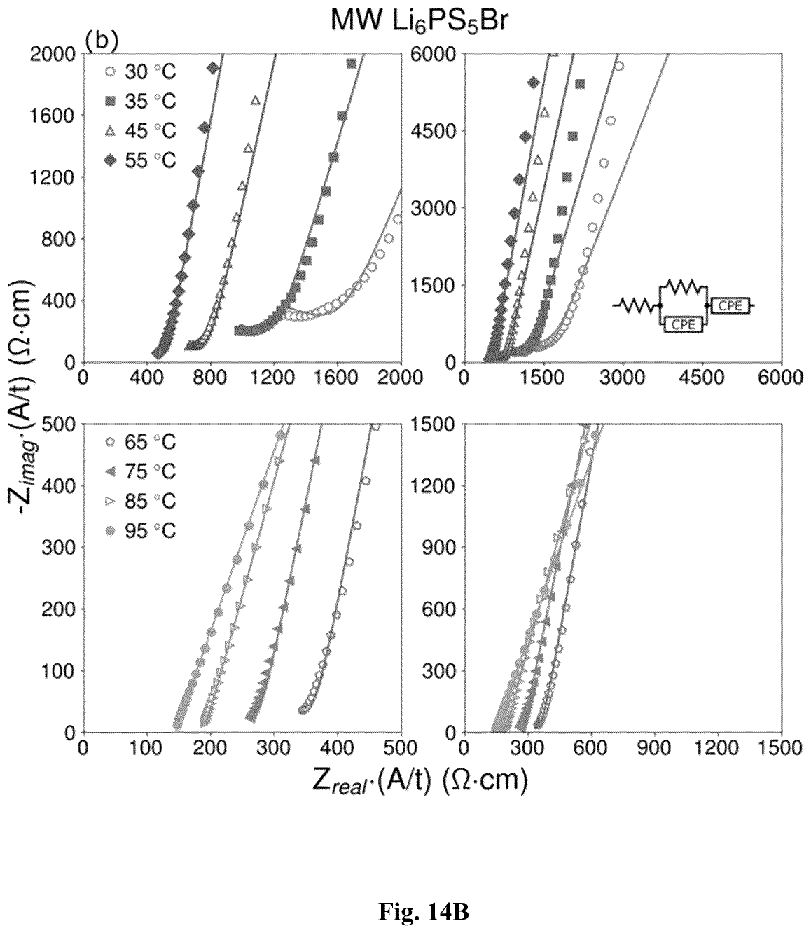

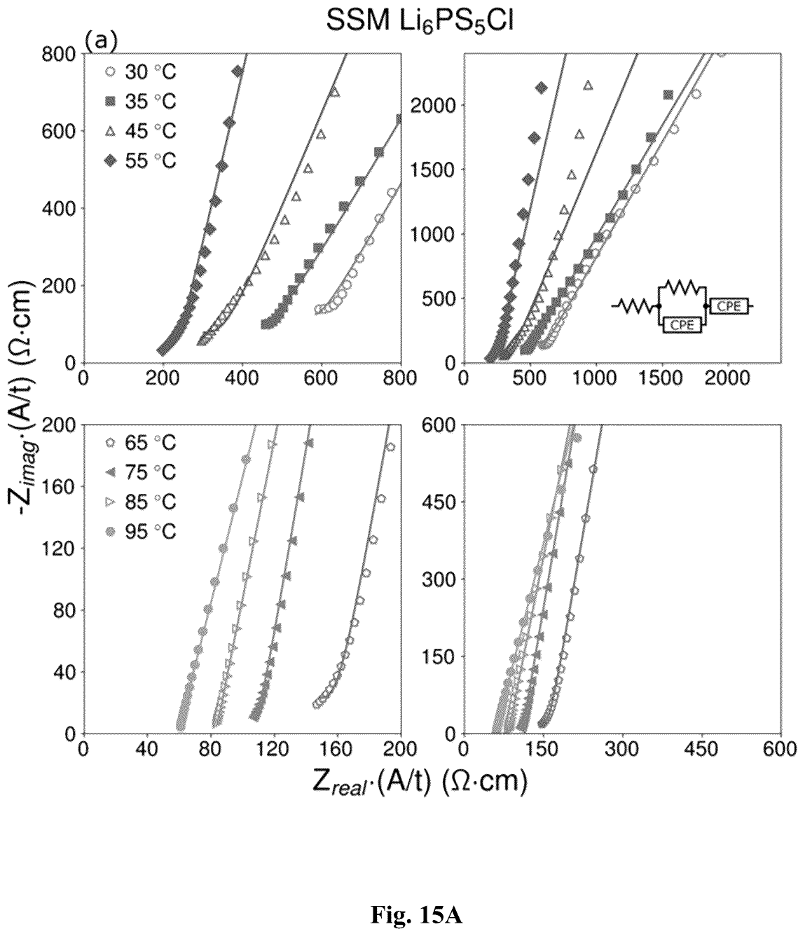

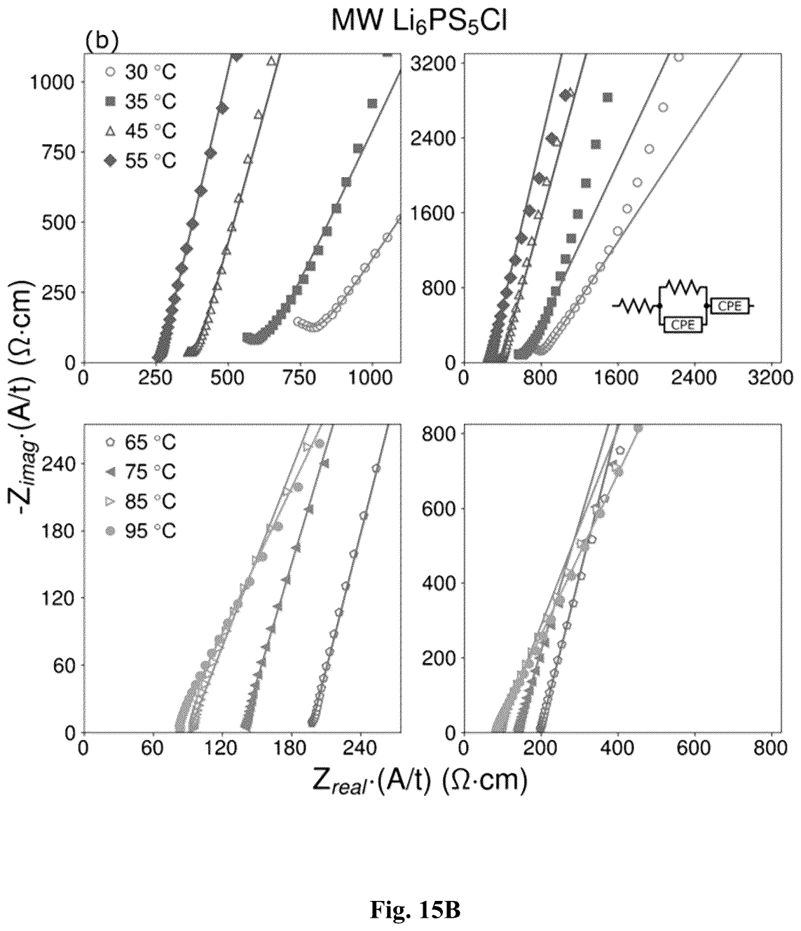

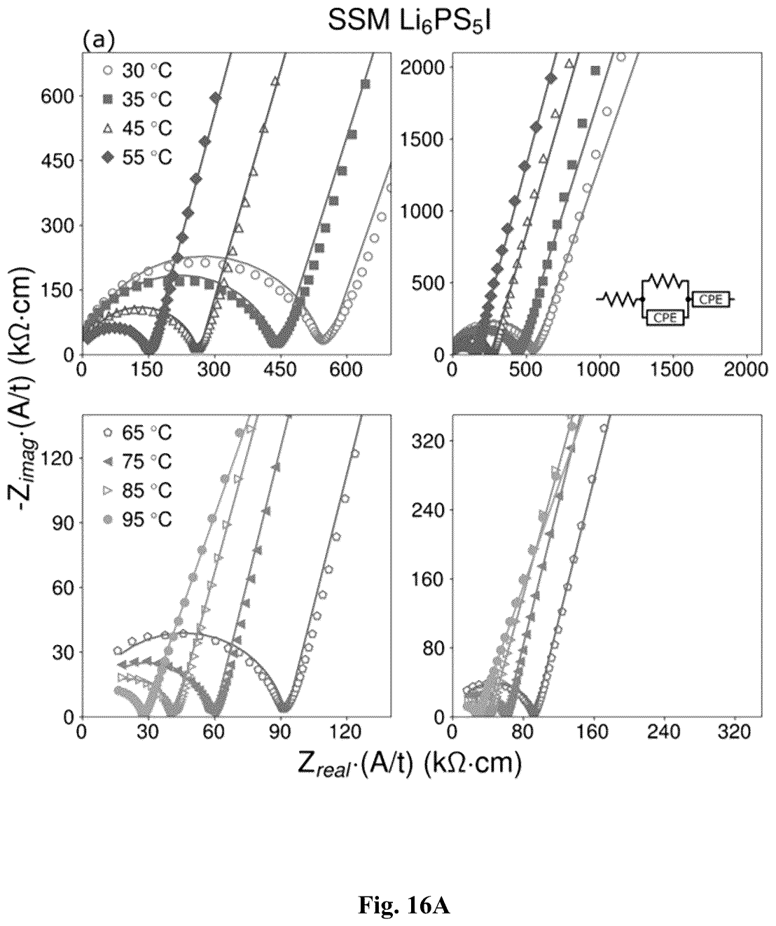

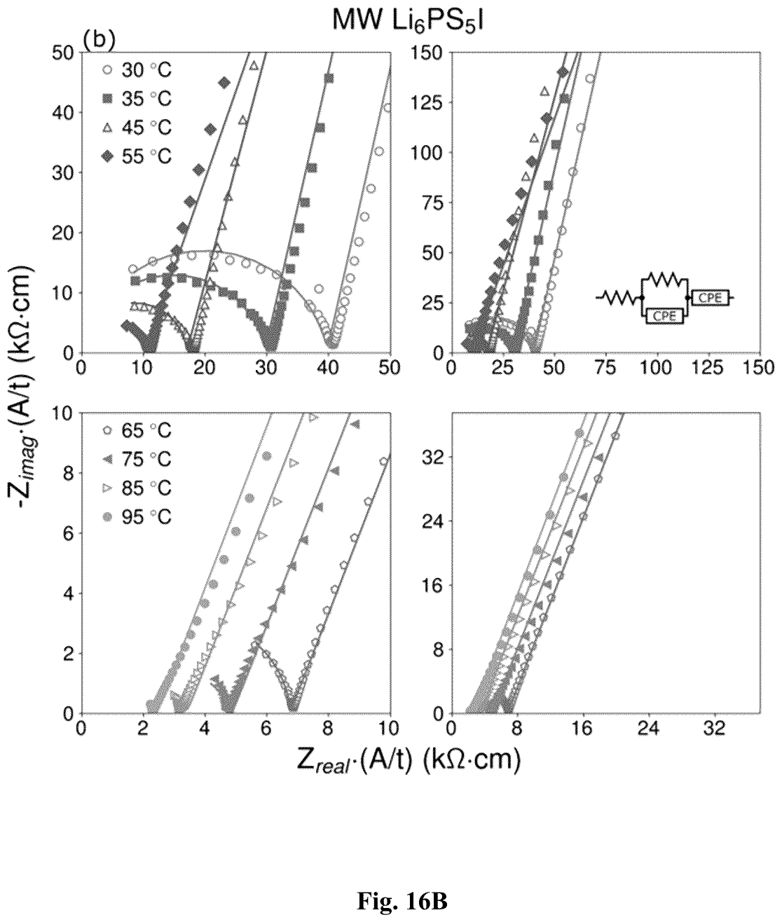

To further probe the electrochemical performance of the samples, temperature dependent EIS data were collected from 30-95° C. Temperature dependent Nyquist plots of the reference (FIG. 14A) and microwaved (FIG. 14B) Li₆PS₅Br, while equivalent plots for Li₆PS₅Cl and Li₆PS₅I are displayed in FIG. 15A-15B and FIG. 16A-16B, respectively.

Ionic conductivity values (FIG. 13E) were extracted from the EIS data at each temperature and activation energies were calculated via the Arrhenius relationship shown in Equation 1, where Eₐ is the activation energy and go is a pre-factor that accounts for non-thermal contributions to ionic conductivity.

$$σ T = {σ}_{0} {e}^{- {E}_{a} / {k}_{B} T} \qquad ( Eq . 1 )$$

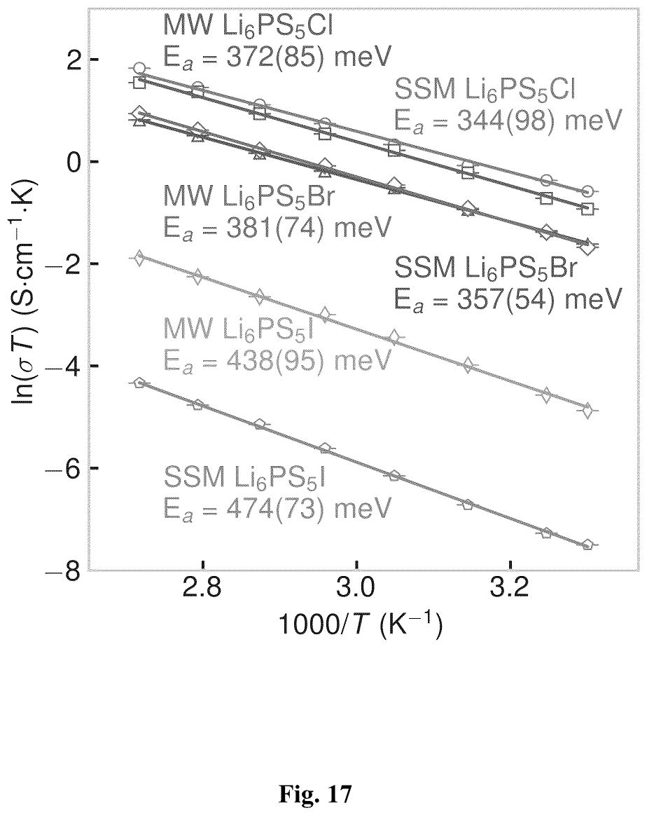

For all three argyrodites, the activation energies of the microwaved materials were comparable to those of their reference method analogues (FIG. 17, FIG. 13D). It is of note that the MW Li₆PS₅I exhibited an ionic conductivity approximately one order of magnitude greater than that of its reference analogue. Further, all microwaved materials exhibited higher Arrhenius prefactors than their reference analogues (FIG. 13F), which exerts a positive influence on ionic conductivity. Both MW Li₆PS₅Cl and Li₆PS₅Br exhibited ionic conductivities similar those observed for their reference analogues (˜1 mS/cm), indicating that the microwave method generates materials with competitive bulk electrochemical performance.

The present invention may be further understood from the following non-limiting examples:

Example 1. A method comprising:
providing a powdered argyrodite precursor; and
exposing the powdered argyrodite precursor to microwave radiation, thereby generating an argyrodite material.

Example 2. The method of example 1 with the proviso that the step of exposing is performed without a solvent present in the powdered argyrodite precursor.

Example 3. The method of example 1 or 2, further comprising:
positioning the powered argyrodite precursor proximate to a susceptor, wherein the susceptor generates thermal energy when exposed to microwave radiation.

Example 4. The method of example 3, wherein the susceptor comprises charcoal.

Example 5. The method of example 1 or 2, wherein the argyrodite material comprises Li7-yPS6-yXy (X═Cl, Br, I).

Example 6. The method of example 3, wherein the argyrodite material is Li6PS5Cl, Li6PS5Br, Li6PS5I or a combination thereof.

Example 7. The method of any of examples 1-4, wherein the microwave radiation has a wavelength selected from the range of 1 m to 1 mm.

Example 8. The method of any of examples 1-5, wherein the microwave radiation is provided at a power or energy flux selected from the range of 500 W/m2 to 2500 W/m2.

Example 9. The method of any of examples 1-6, wherein the argyrodite material is a solid electrolyte.

Example 10. The method of any of examples 1-7, wherein the step of exposing is performed for a time period less than or equal to 1 hr.

Example 11. A material comprising:
an argyrodite solid electrolyte comprising Li7-yPS6-yXy, where X═Cl, Br, or I;
wherein the reference analog of the argyrodite solid electrolyte is less than or equal to 5 mol % of electrolyte.

Example 12. The material of example 11, wherein the material is generated by exposing a precursor to microwave radiation in the absence of a solvent.

Example 13. The material of example 11 or 12, wherein the argyrodite solid electrolyte is Li6PS5Cl, Li6PS5Br, Li6PS5I or a combination thereof.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
providing a powdered argyrodite precursor; and
exposing the powdered argyrodite precursor to microwave radiation, thereby generating an argyrodite material.

2. The method of claim 1 with the proviso that the step of exposing is performed without a solvent present in the powdered argyrodite precursor.

3. The method of claim 1, further comprising:
positioning the powered argyrodite precursor proximate to a susceptor, wherein the susceptor generates thermal energy when exposed to microwave radiation.

4. The method of claim 3, wherein the susceptor comprises charcoal.

5. The method of claim 1, wherein the argyrodite material comprises Li_{7-y}PS_{6-y}X_{y} (X═Cl, Br, I).

6. The method of claim 3, wherein the argyrodite material is Li₆PS₅Cl, Li₆PS₅Br, Li₆PS₅I or a combination thereof.

7. The method of claim 1, wherein the microwave radiation has a wavelength selected from the range of 1 m to 1 mm.

8. The method of claim 1, wherein the microwave radiation is provided at a power or energy flux selected from the range of 500 W/m² to 2500 W/m².

9. The method of claim 1, wherein the argyrodite material is a solid electrolyte.

10. The method of claim 1, wherein the step of exposing is performed for a time period less than or equal to 1 hr.

11. A material comprising:
an argyrodite solid electrolyte comprising Li_{7-y}PS_{6-y}X_{y}, where X═Cl, Br, or I;
wherein the reference analog of the argyrodite solid electrolyte is less than or equal to 5 mol % of electrolyte.

12. The material of claim 11, wherein the material is generated by exposing a precursor to microwave radiation in the absence of a solvent.

13. The material of claim 11, wherein the argyrodite solid electrolyte is Li₆PS₅Cl, Li₆PS₅Br, Li₆PS₅I or a combination thereof.
